(19) United States
(12) Patent Application Publication
(10) Pub. No.: US 2025/0226558 A1
(43) Pub. Date: Jul. 10, 2025

(54) CATHODE INSULATION COATING

(71) Applicant: GM GLOBAL TECHNOLOGY OPERATIONS LLC, DETROIT, MI (US)

(72) Inventors: Nicholas Ware, East Lansing, MI (US); Xiaowei Yu, Farmington Hills, MI (US); Ming Wang, Stering Heights, MI (US)

(21) Appl. No.: 18/409,211

(22) Filed: Jan. 10, 2024

(51) Int. Cl. H01M 50/593; H01M 4/02; H01M 4/04

(52) U.S. Cl. CPC H01M 50/593; H01M 4/0402; H01M 2004/021; H01M 2004/028; H01M 2220/20

(57) ABSTRACT

Aspects of the disclosure include cathode insulation coatings and coating overlap designs that leverage a porous deposition of cathode insulation coating material. An exemplary vehicle includes an electric motor and a battery pack electrically coupled to the electric motor. The battery pack includes a plurality of battery cells. Each battery cell includes a cathode current collector having a cathode tab, a cathode active material dispersed over the cathode current collector, and a cathode insulation coating. The cathode insulation coating is formed directly on a portion of the cathode active material and directly on a portion of the cathode tab. The cathode insulation coating includes a porous macrostructure that is patterned such that portions of the cathode active material underlying the cathode insulation coating are exposed, thereby providing a porous cathode insulation coating that protects against separator misalignment and slippage with a reduced loss in ion transport dynamics.

### INTRODUCTION

The present disclosure relates to battery cell and electrode manufacturing, and particularly to a cathode insulation coating and coating overlap design.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Copper foil, aluminum foil, stainless steel, and titanium foil are commonly used as the current collector of an electrode. In dry electrode fabrication processes, for example, a film that includes activated carbon powder (e.g., the active electrode material) is attached to a thin aluminum foil using an adhesive layer. To improve the quality of the interfacial bond between the film of active electrode material and the current collector, the combination of the film and the current collector is processed in a pressure laminator, for example, a calender. This process is generally known as calendering. Thus, in a dry manufacturing process the fabrication of an electrode typically involves the production of an active electrode material film and the lamination of that film onto a current collector.

### SUMMARY

In one exemplary embodiment a vehicle includes an electric motor and a battery pack electrically coupled to the electric motor. The battery pack includes a plurality of battery cells. Each battery cell includes a cathode current collector having a cathode tab, a cathode active material dispersed over the cathode current collector, and a cathode insulation coating. The cathode insulation coating is formed directly on a portion of the cathode active material and directly on a portion of the cathode tab. The cathode insulation coating includes a porous macrostructure that is patterned such that portions of the cathode active material underlying the cathode insulation coating are exposed, thereby providing a porous cathode insulation coating that protects against separator misalignment and slippage with a reduced loss in ion transport dynamics.

In addition to one or more of the features described herein, in some embodiments, the porous macrostructure includes a micrometer-scale pattern. In some embodiments, the micrometer-scale pattern includes one or more lines having line widths of less than 15 micrometers.

In some embodiments, the cathode insulation coating includes one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

In some embodiments, the cathode insulation coating includes a porous material. The porous material can include one or more of polytetrafluoroethylene (PTFE), glass fiber, aerogel, a cellulose-based insulative material, and combinations thereof.

In some embodiments, the cathode insulation coating extends to an edge of the cathode current collector and to an edge of the cathode tab. In some embodiments, the cathode insulation coating extends over the cathode active material by a distance of at least 5 millimeters.

In another exemplary embodiment a battery cell includes a cathode current collector having a cathode tab, a cathode active material dispersed over the cathode current collector, and a cathode insulation coating. The cathode insulation coating is formed directly on a portion of the cathode active material and directly on a portion of the cathode tab. The cathode insulation coating includes a porous macrostructure that is patterned such that portions of the cathode active material underlying the cathode insulation coating are exposed, thereby providing a porous cathode insulation coating that protects against separator misalignment and slippage with a reduced loss in ion transport dynamics.

In some embodiments, the porous macrostructure includes a micrometer-scale pattern. In some embodiments, the micrometer-scale pattern includes one or more lines having line widths of less than 15 micrometers.

In some embodiments, the cathode insulation coating includes one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

In some embodiments, the cathode insulation coating includes a porous material. The porous material can include one or more of polytetrafluoroethylene (PTFE), glass fiber, aerogel, a cellulose-based insulative material, and combinations thereof.

In some embodiments, the cathode insulation coating extends to an edge of the cathode current collector and to an edge of the cathode tab. In some embodiments, the cathode insulation coating extends over the cathode active material by a distance of at least 5 millimeters.

In yet another exemplary embodiment a coating process can include providing a cathode current collector comprising a cathode tab, dispersing a cathode active material over the cathode current collector, and forming a cathode insulation coating directly on a portion of the cathode active material and directly on a portion of the cathode tab. The cathode insulation coating includes a porous macrostructure that is patterned such that portions of the cathode active material underlying the cathode insulation coating are exposed, thereby providing a porous cathode insulation coating that protects against separator misalignment and slippage with a reduced loss in ion transport dynamics.

In some embodiments, the porous macrostructure includes a micrometer-scale pattern. In some embodiments, the micrometer-scale pattern includes one or more lines having line widths of less than 15 micrometers.

In some embodiments, the cathode insulation coating includes one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

In some embodiments, the cathode insulation coating includes a porous material. The porous material can include one or more of polytetrafluoroethylene (PTFE), glass fiber, aerogel, a cellulose-based insulative material, and combinations thereof.

In some embodiments, the cathode insulation coating extends to an edge of the cathode current collector and to an edge of the cathode tab. In some embodiments, the cathode insulation coating extends over the cathode active material by a distance of at least 5 millimeters.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A is an example battery cell in accordance with one or more embodiments;

FIG. 2B is a detailed view of the example battery cell shown in FIG. 2A in accordance with one or more embodiments;

FIG. 3 is an example of a portion of a roll-to-roll coating process in accordance with one or more embodiments;

FIG. 4 is another example of a portion of a roll-to-roll coating process in accordance with one or more embodiments;

FIGS. 5A and 5B are example patterns for a porous cathode insulation coating in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Battery manufacturing, such as the production of softly packaged lithium-ion batteries, involves the stacking of a number of electrically isolated electrodes. During this stacking process, the goal is to efficiently arrange multiple layers of electrode materials, separators, and other components to form a structurally sound and electrically functional stack. In many manufacturing processes, the separator(s) are insulated members positioned between adjacent battery components to prevent short circuits and to ensure proper electrical isolation between the electrodes, while allowing the lithium ion in the electrolyte to pass through. Unfortunately, common manufacturing techniques for electrode stacking result in electrode stacks that are susceptible to misalignment. The folding and pressing mechanisms are sensitive steps, and any lapses in securing the folds may lead to electrode slippage and/or separator misalignment. For example, misalignment can occur when an electrode shifts within the stack and can result in a loss in battery efficiency.

To mitigate potential misalignments, many manufacturing processes rely on a cathode insulation coating (CIC) that is applied to the cathode near the cathode tab and tab-side edge to provide redundancy in the battery cell design. Were a separator to be folded, shifted, moved, and/or shrunk at any time in the cell manufacture or during cell field-usage, or were there to be any electrode lamination mismatch, the CIC structurally provides an insulating layer that prevents contact and subsequent short-circuit between the cathode tab or cathode active material (CAM) and the anode active material (AAM) or anode current collector/tab. The use of a CIC represents a tradeoff, however, as covering the surface of the cathode with the insulative CIC limits electrolyte access and ionic flow (that is, the CIC inhibits electrode surface processes). Consequently, in common practice, the CIC overlaps the cathode by less than 1 mm.

This disclosure introduces a new cathode insulation coating and coating overlap design that leverages a porous deposition of CIC material that provides protective redundancy without sacrificing electrode ion dynamics or electrolyte wetting. Advantageously, a porous CIC can be applied directly onto a cathode current collector using porous materials and/or can be constructed from non-porous materials using a porous deposition technique in a manner that is compatible with roll-to-roll electrode manufacturing processes. Leveraging a porous cathode insulation coating in accordance with one or more embodiments offers several technical advantages over prior electrode stacking manufacturing processes. Notably, a porous CIC does not incur the full extent of the transport and capacity losses inherent to so-called full-coverage CICs (a “full-coverage” CIC refers to a non-porous CIC that is conventionally applied), enabling relatively larger CICs that more strongly overlap the electrode active material, providing extensive protection against edge contact and/or separator failure. In contrast, the region of active material underneath a full-coverage CIC is often considered “inaccessible” for purposes of calculating the usable capacity of a cathode. In other words, a porous CIC constructed as described herein offers a higher usable capacity for the underlying cathode.

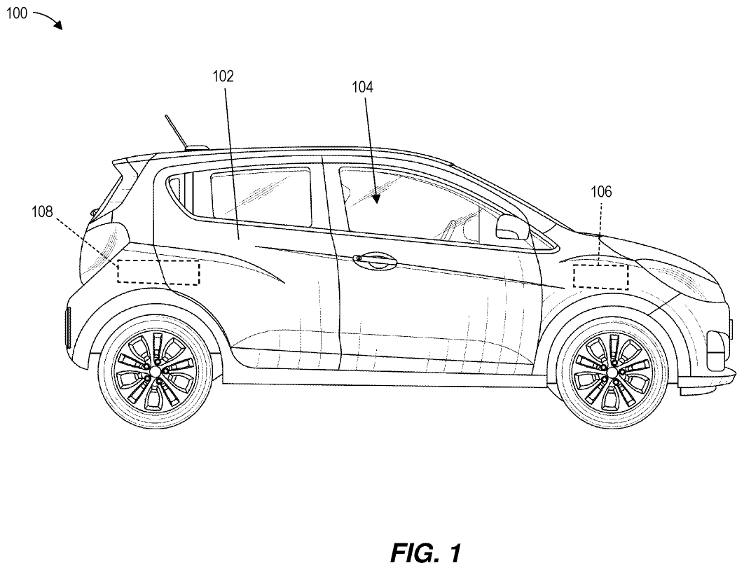

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure. As will be detailed herein, the battery pack 108 includes one or more battery cells and/or battery pouches made from electrode stacks secured in part using a porous CIC.

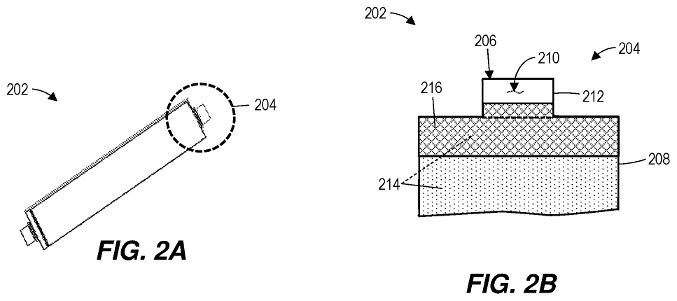

FIG. 2A illustrates an example battery cell 202 in accordance with one or more embodiments. The battery cell 202 can be incorporated as one of a number of battery cells in a battery pack (e.g., the battery pack 108 in FIG. 1). FIG. 2B illustrates a detailed view 204 of the example battery cell 202 shown in FIG. 2A in accordance with one or more embodiments. As shown in FIG. 2B, the battery cell 202 includes a cathode current collector 206 having a side edge 208. The cathode current collector 206 includes a cathode tab 210 having a cathode tab-side edge 212.

A cathode active material 214 is dispersed over the cathode current collector 206. In some embodiments, the cathode active material 214 is dispersed over those portions of the cathode current collector 206 which do not include the cathode tab 210. In other words, the cathode tab 210 is free of the cathode active material 214. A cathode insulation coating 216 is dispersed over the cathode active material 214 (portions of the cathode active material 214 under the cathode insulation coating 216 are indicated via a projection line) and a portion of the cathode tab 210.

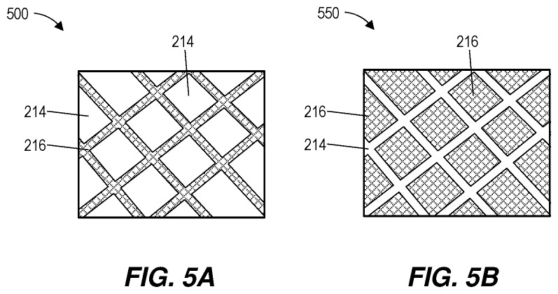

In some embodiments, the cathode insulation coating 216 is a porous cathode insulation coating. As used herein, a “porous” cathode insulation coating refers to a coating that is macroscopically porous and/or microscopically porous. A macroscopically porous cathode insulation coating refers to a coating that is deposited or otherwise formed over the cathode current collector 206 in a pattern having a number of openings (lines, pores, etc.) through which direct contact to the underlying cathode active material 214 is available. A macroscopically porous cathode insulation coating may or may not itself be made of porous materials. Example macroscopically porous cathode insulation coating patterns are shown in FIGS. 5A and 5B. Notably, no specific geometry is required for a macroscopically porous cathode insulation coating. On the other hand, a microscopically porous cathode insulation coating refers to a coating that is made of a porous material, such as, for example, porous membranes made of polymer blends such as polytetrafluoroethylene (PTFE), glass fiber, aerogels, and/or cellulose-based insulative materials.

In some embodiments, the cathode insulation coating 216 is a macroscopically porous cathode insulation coating. In some embodiments, the cathode insulation coating 216 is made of materials which are electrochemically stable at the operating voltage of the electrodes, and which are highly electronically insulative. Some examples include thermoplastic polymers such as polyvinylidene fluoride (PVDF), polyethylene (PE), including high-density polyethylene (HDPE) and low-density polyethylene (LDPE), polypropylene (PP), polyacrylic acid or polyacrylate (PAA), and their mixtures, anode-type binders such as styrene butadiene rubber (SBR) and carboxymethyl cellulose (CMC), and/or any other type of highly adhesive, inert formable coating. In addition, these materials and their mixtures may include ceramics and/or other ingredients which improve the performance, viscosity, formation, deposition, resistivity, color, or any other property of the cathode insulation coating 216.

As shown in FIG. 2B, the cathode insulation coating 216 can be applied to extend over the cathode active material 214 all the way to the side edge 208 of the cathode current collector 206. In addition, the cathode insulation coating 216 can extend over all or a portion (as shown) of the cathode tab 210 all the way to the cathode tab-side edge 212. In this manner, the cathode insulation coating 216 can protect the cathode current collector 206 near an edge of a separator (included within the battery cell 202, but not separately shown), preventing short circuits (e.g., anode-to-cathode, anode current collector-to-cathode, etc.) that would otherwise occur if the separator was to slip or otherwise become misaligned to the cathode current collector 206.

The battery cell 202 can include additional layers, such as a number of stacked anode current collectors alternating with a number of cathode current collectors (including the cathode current collector 206), and separators positioned between the anode current collectors and the cathode current collectors, as well as active materials (including the cathode active material 214) dispersed within the battery cell 202 to cover the anode current collectors and the cathode current collectors (these additional elements are omitted for simplicity). It should be understood that the battery cell 202 can include any number of layers (e.g., anode and cathode layers) and a corresponding number of separators and any amount of active material as desired, and all such configurations are within the contemplated scope of this disclosure.

The anode current collectors and cathode current collectors can be made of sheets or foils of conductive metal. For example, the cathode current collectors can be made of aluminum foil, stainless steel, and/or titanium foil, to which an active material is attached. Other materials are possible, such as, for example, semimetals (e.g., tin, graphite) and alloys of the metals and/or semimetals thereof. In some embodiments, the cathode current collectors are made of aluminum foil. The anode current collectors can include coated copper foils, although other materials are possible and within the contemplated scope of this disclosure.

The separators can include dielectric materials such as, for example, polyethylene (PE), polypropylene (PP), polyethylene terephthalate (PET), and composites thereof, although other dielectrics are within the contemplated scope of this disclosure.

The active materials are not meant to be particularly limited, but can include, for example, various cathode or anode materials (depending on the requirements of a specific application), such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LMO), graphite, silicon, silicon-graphite composites, tin, tin oxide (SnO₂), lithium titanate (Li₄Ti₅O₁₂, LTO), sulfur and lithium-sulfur (Li—S) composites, lithium metal (Li), and/or lithium alloys such as lithium-antimony (Li—Sb), lithium-aluminum (Li—Al), and lithium-germanium (Li—Ge).

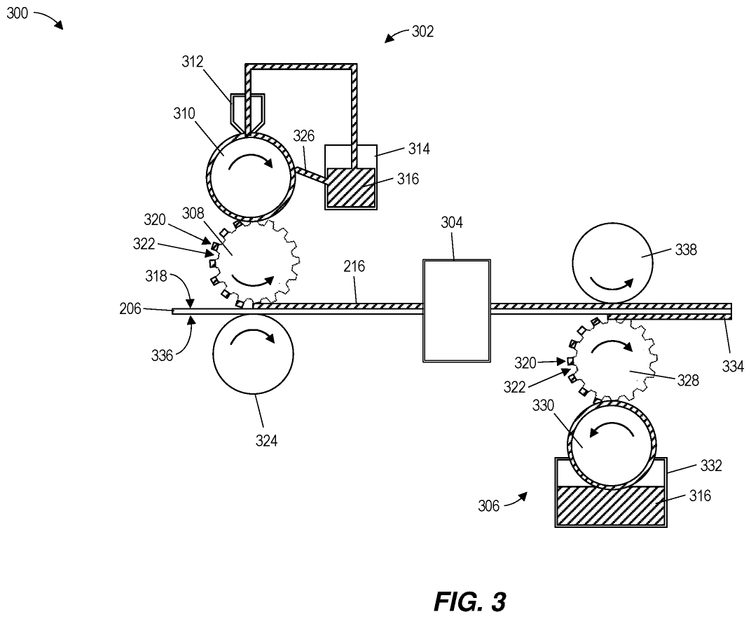

FIG. 3 illustrates an example roll-to-roll coating process 300 in accordance with one or more embodiments. As shown in FIG. 3, the roll-to-roll coating process 300 includes a top coating unit 302, a drying unit 304, and a bottom coating unit 306, sequenced as shown. While not separately shown, the roll-to-roll coating process 300 can further include additional upstream and downstream fabrication units, such as a calendaring unit upstream of the top coating unit 302.

In some embodiments, the top coating unit 302 includes a patterned roll 308, a fountain roll 310, a solution coater 312, and a solution container 314 having therein a coating material 316. The coating material 316 can include, for example, a thermoplastic polymer bath, an anode-type binder solution, and/or any other material source for cathode insulation coatings. In some embodiments, the patterned roll 308 is positioned to deposit the coating material 316 on a cathode current collector 206, thereby forming a cathode insulation coating 216 on a top surface 318 of the cathode current collector 206.

In some embodiments, the patterned roll 308 includes one or more raised surfaces 320 and a nominal surface(s) 322. In some embodiments, the patterned roll 308 and the raised surfaces 320 are positioned against the fountain roll 310 such that the raised surfaces 320 can be coated with the coating material 316 as the patterned roll 308 rotates. The nominal surface 322, which is recessed with respect to the raised surfaces 320, is not coated with the coating material 316. Observe that, by changing an arrangement (pattern, size, distribution, etc.) of the raised surfaces 320, the patterned roll 308 can deposit a cathode insulation coating 216 having any desired pattern or structure. FIG. 5A depicts an example pattern resulting from the roll-to-roll coating process 300.

The fountain roll 310 is positioned between the patterned roll 308 and the solution coater 312. In some embodiments, the fountain roll 310 is configured to rotate below the solution coater 312 so that the coating material 316 can be evenly dispensed by the solution coater 312 across the fountain roll 310.

In some embodiments, a back-up roll 324 is positioned opposite the patterned roll 308. The back-up roll 324 can be positioned to provide a fixed surface against which the patterned roll 308 can press, allowing the coating material 316 to be transferred to the top surface 318 of the cathode current collector 206. In some embodiments, the back-up roll 324 is configured to rotate in a direction opposite the patterned roll 308, thereby allowing, in combination with the patterned roll 308, the cathode current collector 206 to be pulled along the roll-to-roll coating process 300. The roll-to-roll coating process 300 can also include any number of additional positioning rollers for this purpose, although those are omitted for convenience.

In some embodiments, the top coating unit 302 includes a doctor blade 326 positioned against the fountain roll 310 and coupled to the solution container 314. In some embodiments, the doctor blade 326 is configured to remove excess coating material 316 from the fountain roll 310, thereby allowing the excess coating material 316 to be recovered back into the solution container 314.

In some embodiments, the drying unit 304 follows the top coating unit 302. While not meant to be particularly limited, the drying unit 304 can include, for example, a furnace, an oven, and/or any other heating element for heating and drying the cathode current collector 206 after depositing the cathode insulation coating 216.

In some embodiments, the bottom coating unit 306 follows the drying unit 304. In some embodiments, the bottom coating unit 306 includes a patterned roll 328, a fountain roll 330, and a solution container 332 having therein the coating material 316. In some embodiments, the patterned roll 328 is positioned to deposit the coating material 316 on the cathode current collector 206, thereby forming a cathode insulation coating 334 on a bottom surface 336 of the cathode current collector 206.

In some embodiments, the patterned roll 328 includes one or more raised surfaces 320 and a nominal surface(s) 322, in a similar manner as described with respect to the patterned roll 308 of the top coating unit 302, although the pattern of raised surfaces 320 can be the same, or different, as desired. In some embodiments, the patterned roll 328 and the raised surfaces 320 are positioned against the fountain roll 330 such that the raised surfaces 320 can be coated with the coating material 316 as the patterned roll 328 rotates. The nominal surface 322, which is recessed with respect to the raised surfaces 320, is not coated with the coating material 316.

The fountain roll 330 is positioned between the patterned roll 328 and the solution container 332. In some embodiments, the fountain roll 310 is configured to rotate within the solution container 332 so that the coating material 316 can be evenly dispensed across the fountain roll 330.

In some embodiments, a back-up roll 338 is positioned opposite the patterned roll 328. The back-up roll 338 can be positioned to provide a fixed surface against which the patterned roll 328 can press, allowing the coating material 316 to be transferred to the bottom surface 336 of the cathode current collector 206. In some embodiments, the back-up roll 338 is configured to rotate in a direction opposite the patterned roll 328, thereby allowing, in combination with the patterned roll 328, the cathode current collector 206 to be pulled along the roll-to-roll coating process 300.

In some embodiments, the bottom coating unit 306 includes a doctor blade (not separately shown) positioned against the fountain roll 330 and coupled to the solution container 332. In some embodiments, the doctor blade is configured to remove excess coating material 316 from the fountain roll 330, thereby allowing the excess coating material 316 to be recovered back into the solution container 332.

In some embodiments, the roll-to-roll coating process 300 includes both the top coating unit 302 and the bottom coating unit 306. In this type of configuration, the roll-to-roll coating process 300 is a double-sided coating process (as shown). In some embodiments, the roll-to-roll coating process 300 includes only one of the top coating unit 302 and the bottom coating unit 306. In this type of configuration, the roll-to-roll coating process 300 is a single-sided coating process. In either case, the cathode insulation coating 216 and/or cathode insulation coating 334 can be deposited to any desirable thickness onto the cathode current collector 206. While not meant to be particularly limited, the cathode insulation coating 216 and/or cathode insulation coating 334 can be deposited to a thickness of, for example, 5 to 30 nanometers. The cathode insulation coating 216 and the cathode insulation coating 334 can be deposited to a same thickness, or a different thickness, as desired.

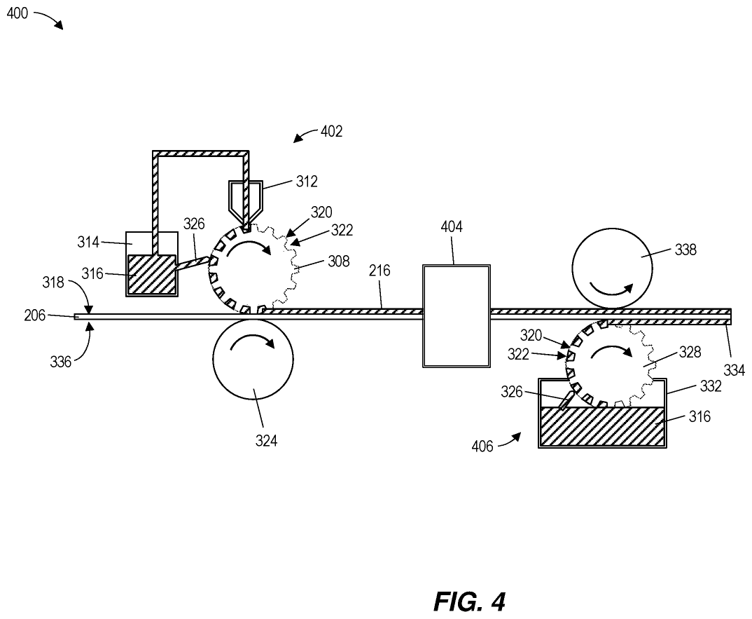

FIG. 4 illustrates an example roll-to-roll coating process 400 in accordance with one or more embodiments. As shown in FIG. 4, the roll-to-roll coating process 400 includes a top coating unit 402, a drying unit 404, and a bottom coating unit 406, sequenced as shown. While not separately shown, the roll-to-roll coating process 400 can further include additional upstream and downstream fabrication units, such as a calendaring unit upstream of the top coating unit 402.

In some embodiments, the top coating unit 402 includes a patterned roll 308, a solution coater 312, and a solution container 314 having therein a coating material 316. In some embodiments, the patterned roll 308 is positioned to deposit the coating material 316 on a cathode current collector 206, thereby forming a cathode insulation coating 216 on a top surface 318 of the cathode current collector 206.

In some embodiments, the patterned roll 308 includes one or more raised surfaces 320 and a nominal surface(s) 322. In some embodiments, the patterned roll 308 and the raised surfaces 320 are positioned against the solution coater 312 such that the nominal surface(s) 322 can be coated with the coating material 316 as the patterned roll 308 rotates. Notably, in this configuration, the raised surfaces 320 are not coated with the coating material 316, in contrast to the roll-to-roll coating process 300 discussed previously. Observe that, by changing an arrangement (pattern, size, distribution, etc.) of the raised surfaces 320, the patterned roll 308 can deposit a cathode insulation coating 216 having any desired pattern or structure. FIG. 5B depicts an example pattern resulting from the roll-to-roll coating process 400.

In some embodiments, a back-up roll 324 is positioned opposite the patterned roll 308. The back-up roll 324 can be positioned to provide a fixed surface against which the patterned roll 308 can press, allowing the coating material 316 to be transferred to the top surface 318 of the cathode current collector 206. In some embodiments, the back-up roll 324 is configured to rotate in a direction opposite the patterned roll 308, thereby allowing, in combination with the patterned roll 308, the cathode current collector 206 to be pulled along the roll-to-roll coating process 400. The roll-to-roll coating process 400 can also include any number of additional positioning rollers for this purpose, although those are omitted for convenience.

In some embodiments, the top coating unit 402 includes a doctor blade 326 positioned against the patterned roll 308 and coupled to the solution container 314. In some embodiments, the doctor blade 326 is configured to clear (clean) the raised surfaces 320, such that the raised surfaces 320 are free of the coating material 316. In some embodiments, the coating material 316 removed from the patterned roll 308 is recovered back into the solution container 314.

In some embodiments, the drying unit 404 follows the top coating unit 402. While not meant to be particularly limited, the drying unit 404 can include, for example, a furnace, an oven, and/or any other heating element for heating and drying the cathode current collector 206 after depositing the cathode insulation coating 216.

In some embodiments, the bottom coating unit 406 follows the drying unit 404. In some embodiments, the bottom coating unit 406 includes a patterned roll 328 and a solution container 332 having therein the coating material 316. In some embodiments, the patterned roll 328 is positioned to deposit the coating material 316 on the cathode current collector 206, thereby forming a cathode insulation coating 334 on a bottom surface 336 of the cathode current collector 206.

In some embodiments, the patterned roll 328 includes one or more raised surfaces 320 and a nominal surface(s) 322, in a similar manner as described with respect to the patterned roll 308 of the top coating unit 402, although the pattern of raised surfaces 320 can be the same, or different, as desired. In some embodiments, the patterned roll 328 is positioned within the solution container 332 such that the nominal surface(s) 322 can be coated with the coating material 316 as the patterned roll 328 rotates. In some embodiments, the bottom coating unit 406 includes a doctor blade 326 positioned against the patterned roll 328 and coupled to the solution container 332. In some embodiments, the doctor blade 326 is configured to clear (clean) the raised surfaces 320, such that the raised surfaces 320 are free of the coating material 316 prior to contact with the bottom surface 336 of the cathode current collector 206. In some embodiments, the coating material 316 removed from the patterned roll 328 is recovered back into the solution container 332.

In some embodiments, a back-up roll 338 is positioned opposite the patterned roll 328. The back-up roll 338 can be positioned to provide a fixed surface against which the patterned roll 328 can press, allowing the coating material 316 to be transferred to the bottom surface 336 of the cathode current collector 206. In some embodiments, the back-up roll 338 is configured to rotate in a direction opposite the patterned roll 328, thereby allowing, in combination with the patterned roll 328, the cathode current collector 206 to be pulled along the roll-to-roll coating process 300.

In some embodiments, the roll-to-roll coating process 400 includes both the top coating unit 402 and the bottom coating unit 406. In this type of configuration, the roll-to-roll coating process 400 is a double-sided coating process (as shown). In some embodiments, the roll-to-roll coating process 400 includes only one of the top coating unit 402 and the bottom coating unit 406. In this type of configuration, the roll-to-roll coating process 400 is a single-sided coating process. In either case, the cathode insulation coating 216 and/or cathode insulation coating 334 can be deposited to any desirable thickness onto the cathode current collector 206. While not meant to be particularly limited, the cathode insulation coating 216 and/or cathode insulation coating 334 can be deposited to a thickness of, for example, 5 to 30 nanometers. The cathode insulation coating 216 and the cathode insulation coating 334 can be deposited to a same thickness, or a different thickness, as desired.

Note that, while the roll-to-roll coating processes 300 and 400 are discussed primarily in the context of patterned rolls, other manufacturing processes for depositing porous cathode insulation coatings, such as, for example, additive manufacturing, vapor deposition (with or without masking), spray-coating (via stencils, masks, etc.), gravure printing, etc., can be used in conjunction with, or as a replacement for, the patterned rolls described herein and all such combinations are within the contemplated scope of this disclosure.

FIGS. 5A and 5B illustrate example patterns for a porous cathode insulation coating in accordance with one or more embodiments. In particular, FIG. 5A is an example pattern 500 following the roll-to-roll coating processes 300 described previously with respect to FIG. 3, and FIG. 5B is an example pattern 550 following the roll-to-roll coating processes 400 described previously with respect to FIG. 4. The pattern 500 can be referred to as an outlined grid pattern, and the pattern 550 can be referred to as a brick pattern. The pattern 500 and the pattern 550 are illustrative only, and other patterns, such as a woven geometry, zig-zag geometry, crisscross pattern, honeycomb pattern, perforated holes, etc., are possible and within the contemplated scope of this disclosure.

Observe that, because the cathode insulation coating 216 is deposited in the outlined grid pattern and the brick pattern, respectively, portions of the underlying cathode active material 214 remain exposed. That is, depositing the cathode insulation coating 216 as described previously herein (refer, e.g., to FIGS. 3 and 4) results in a porous cathode insulation coating having a porous macrostructure. Moreover, the patterns 500, 550 shown in FIGS. 5A and 5B are enlarged to better illustrate their respective patterning details. In some embodiments, less than 25 percent, less than 10 percent, less than 5 percent, less than 3 percent, or less than 1 percent of the surface of the cathode active material 214 is covered. In some embodiments, pattern 500 and/or pattern 550 are so-called micrometer-scale patterns. In this type of configuration, 500 and/or pattern 550 include line widths on the order of a few micrometers, for example, less than 15 micrometers, or between 0.5 and 5 micrometers.

In some embodiments, the cathode insulation coating 216 can include two or more hierarchies of porous macrostructures and microstructures to enable ionic flow. For example, the cathode insulation coating 216 can be deposited in a crisscross pattern (or pattern 500, or pattern 550, etc.) using porous materials. That is, the structures within the linewidth of the deposited pattern can themselves be porous. Such a porous cathode insulation coating 216 can be formed using a porous PVDF coating deposited on aluminum by extrusion printing, although other techniques are possible and within the contemplated scope of this disclosure.

By applying the cathode insulation coating 216 in this manner over the cathode active material 214, the safety factor of protection against separator failure or slippage is enhanced significantly. Moreover, by applying the cathode insulation coating 216 in a manner which results in a porous macrostructure (e.g., crisscross pattern, etc.), an electrolyte in a battery cell including the cathode active material 214 is not prevented from delivering ionic current to the underlying cathode active material 214 on the microscopic level, regardless of whether the cathode insulation coating 216 is made of porous or non-porous materials. In addition, as shown in pattern 500 and pattern 550, only a portion of the cathode active material 214 is covered. Thus, the cathode insulation coating 216 only marginally reduces the total active surface area of the respective electrode.

While pattern 500 and pattern 550 are illustrative, the cathode insulation coating 216 can be deposited in any arbitrary pattern, so long as the resulting structure inherently provides porosity so that an electrolyte can penetrate and transport through the cathode insulation coating 216. In other words, by utilizing a cathode insulation coating 216 having a porous macrostructure (of any desired configuration), macroscopic sub-components (e.g., anode, cathode, current collector, etc.) are prevented from short-circuit contacts, while on the microscopic scale, electrolyte is able to reach arbitrarily large (depending only on the selected pattern) portions of the active surface area of the cathode active material 214. The result is a negligible loss in ion transport dynamics because neither contact with the electrolyte, nor the ability of the electric current to reach all active particles, are disrupted.

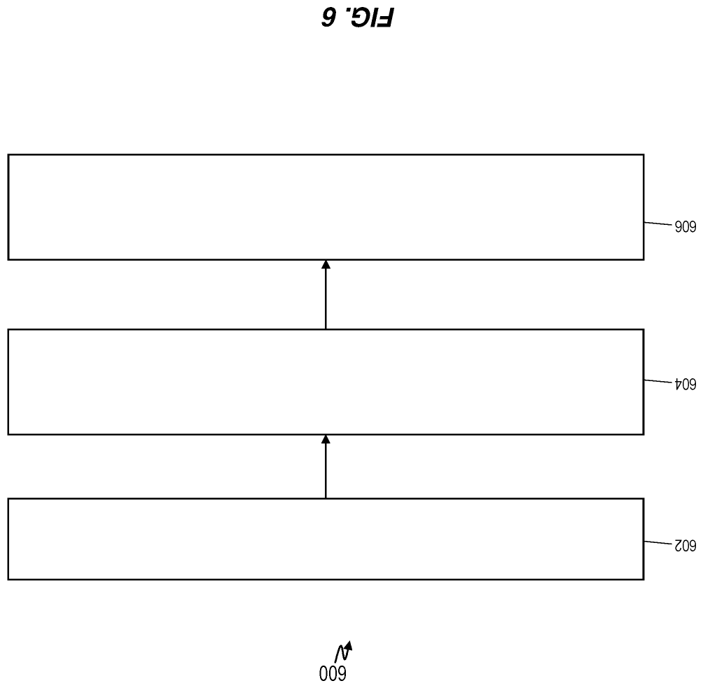

Referring now to FIG. 6, a flowchart 600 for coating a cathode current collector with a cathode insulation coating is generally shown according to an embodiment. The flowchart 600 is described in reference to FIGS. 1-5B and may include additional steps not depicted in FIG. 6. Although depicted in a particular order, the blocks depicted in FIG. 6 can be rearranged, subdivided, and/or combined.

At block 602, the method includes providing a cathode current collector having a cathode tab.

At block 604, the method includes dispersing a cathode active material over the cathode current collector.

At block 606, the method includes forming a cathode insulation coating directly on a portion of the cathode active material and directly on a portion of the cathode tab.

In some embodiments, the cathode insulation coating includes a porous macrostructure that is patterned such that portions of the cathode active material underlying the cathode insulation coating are exposed, thereby providing a porous cathode insulation coating that protects against separator misalignment and slippage with a reduced loss in ion transport dynamics.

In some embodiments, the porous macrostructure includes a micrometer-scale pattern. In some embodiments, the micrometer-scale pattern includes one or more lines having line widths of less than 15 micrometers.

In some embodiments, the cathode insulation coating includes one or more of a thermoplastic polymer, PVDF, PE, HDPE, LDPE, PP, polyacrylic acid, PAA, an anode-type binder, SBR, carboxymethyl cellulose, and combinations thereof.

In some embodiments, the cathode insulation coating includes a porous material, such as one or more of PTFE, glass fiber, aerogel, a cellulose-based insulative material, and combinations thereof.

In some embodiments, the cathode insulation coating extends to an edge of the cathode current collector and to an edge of the cathode tab.

In some embodiments, the cathode insulation coating extends over the cathode active material by a distance of at least 5 millimeters. In some embodiments, the cathode insulation coating extends over the cathode active material by a distance of at least 10 millimeters.

In some embodiments, the cathode insulation coating extends over all of the cathode active material. In some embodiments, the cathode insulation coating extends over at least 10 percent, 20 percent, 30 percent, 40 percent, 50 percent, 60 percent, 70, percent, 80 percent, 90 percent of the cathode active material.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a plurality of battery cells, each battery cell of the plurality of battery cells comprising:
a cathode current collector comprising a cathode tab;
a cathode active material dispersed over the cathode current collector; and
a cathode insulation coating, the cathode insulation coating directly on a portion of the cathode active material and directly on a portion of the cathode tab;
wherein the cathode insulation coating comprises a porous macrostructure that is patterned such that portions of the cathode active material underlying the cathode insulation coating are exposed, thereby providing a porous cathode insulation coating that protects against separator misalignment and slippage with a reduced loss in ion transport dynamics.

2. The vehicle of claim 1, wherein the porous macrostructure comprises a micrometer-scale pattern.

3. The vehicle of claim 2, wherein the micrometer-scale pattern comprises one or more lines having line widths of less than 15 micrometers.

4. The vehicle of claim 1, wherein the cathode insulation coating comprises one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

5. The vehicle of claim 1, wherein the cathode insulation coating comprises a porous material, the porous material comprising one or more of polytetrafluoroethylene (PTFE), glass fiber, aerogel, a cellulose-based insulative material, and combinations thereof.

6. The vehicle of claim 1, wherein the cathode insulation coating extends to an edge of the cathode current collector and to an edge of the cathode tab.

7. The vehicle of claim 1, wherein the cathode insulation coating extends over the cathode active material by a distance of at least 5 millimeters.

8. A battery cell comprising:
a cathode current collector comprising a cathode tab;
a cathode active material dispersed over the cathode current collector; and
a cathode insulation coating, the cathode insulation coating directly on a portion of the cathode active material and directly on a portion of the cathode tab;
wherein the cathode insulation coating comprises a porous macrostructure that is patterned such that portions of the cathode active material underlying the cathode insulation coating are exposed, thereby providing a porous cathode insulation coating that protects against separator misalignment and slippage with a reduced loss in ion transport dynamics.

9. The battery cell of claim 8, wherein the porous macrostructure comprises a micrometer-scale pattern.

10. The battery cell of claim 9, wherein the micrometer-scale pattern comprises one or more lines having line widths of less than 15 micrometers.

11. The battery cell of claim 8, wherein the cathode insulation coating comprises one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

12. The battery cell of claim 8, wherein the cathode insulation coating comprises a porous material, the porous material comprising one or more of polytetrafluoroethylene (PTFE), glass fiber, aerogel, a cellulose-based insulative material, and combinations thereof.

13. The battery cell of claim 8, wherein the cathode insulation coating extends to an edge of the cathode current collector and to an edge of the cathode tab.

14. The battery cell of claim 8, wherein the cathode insulation coating extends over the cathode active material by a distance of at least 5 millimeters.

15. A coating process for a battery cell, the coating process comprising:
providing a cathode current collector comprising a cathode tab;
dispersing a cathode active material over the cathode current collector; and
forming a cathode insulation coating directly on a portion of the cathode active material and directly on a portion of the cathode tab;
wherein the cathode insulation coating comprises a porous macrostructure that is patterned such that portions of the cathode active material underlying the cathode insulation coating are exposed, thereby providing a porous cathode insulation coating that protects against separator misalignment and slippage with a reduced loss in ion transport dynamics.

16. The coating process of claim 15, wherein the porous macrostructure comprises a micrometer-scale pattern.

17. The coating process of claim 16, wherein the micrometer-scale pattern comprises one or more lines having line widths of less than 15 micrometers.

18. The coating process of claim 15, wherein the cathode insulation coating comprises one or more of a thermoplastic polymer, polyvinylidene fluoride (PVDF), polyethylene (PE), high-density polyethylene (HDPE), low-density polyethylene (LDPE), polypropylene (PP), polyacrylic acid, polyacrylate (PAA), an anode-type binder, styrene butadiene rubber (SBR), carboxymethyl cellulose, and combinations thereof.

19. The coating process of claim 15, wherein the cathode insulation coating comprises a porous material, the porous material comprising one or more of polytetrafluoroethylene (PTFE), glass fiber, aerogel, a cellulose-based insulative material, and combinations thereof.

20. The coating process of claim 15, wherein the cathode insulation coating extends to an edge of the cathode current collector and to an edge of the cathode tab, and wherein the cathode insulation coating extends over the cathode active material by a distance of at least 5 millimeters.
